(19) United States
(12) Patent Application Publication
(10) Pub. No.: US 2003/0164452 A1
(43) Pub. Date: Sep. 4, 2003

(54) Method of imaging by spect

(76) Inventors: Adrianus A. Van Dulmen, Cz Schoorl (NL); Stephan Walrand, Silenriex (BE)

Correspondence Address: FINNEGAN, HENDERSON, FARABOW, GARRETT & DUNNER, LLP, 1300 I STREET, NW, WASHINGTON, DC, 20005, US

(21) Appl. No.: 10/297,260

(22) PCT Filed: May 7, 2001
(86) PCT No.: PCT/EP01/05101

(30) Foreign Application Priority Data
Jun. 5, 2000 (EP) 00201971.9

(51) Int. Cl. G01T 1/167

(52) U.S. Cl. 250/370.09

(57) ABSTRACT

The invention relates to a method of imaging a target organ in a patient by SPECT, by using a gamma camera having a gamma detector, and by computer reconstructing the distribution of the radioactivity inside the patient's body from planar images, acquired along at least one linear orbit performed in a transverse direction, the so-called LOrA tomographic method, wherein the gamma detector is a solid-state detector having a transverse width that is smaller than the cross-section of the patient's body. The invention further relates to a combination of said gamma detector and a suitable collimator, and to a gamma camera provided therewith.

The invention relates to a method of imaging a target organ in a patient by SPECT, by using a gamma camera having a gamma detector, and by computer reconstructing the distribution of the radioactivity inside the patient's body from planar images, acquired along at least one linear orbit performed in a transverse direction, wherein said gamma detector is provided on its outer surface with a collimator, selected from a fan-beam collimator and a rake collimator, said fan-beam collimator having a reduced focal length and focusing to a focal line parallel to the patient's body, and said rake collimator having at least one raised wall extending in the longitudinal direction of the detector.

The Single Photon Emission Computed Tomography (SPECT) is routinely used in clinical studies. SPECT is performed by using a gamma camera, comprising a collimator fixed on a gamma detector, which gamma camera follows a revolution orbit around the patient's body. The gamma rays, emitted by a radioactive tracer, accumulated in certain tissues or organs of the patient's body, are sorted by the collimator and recorded by the gamma detector under various angles around the body, the collimator always pointing to (facing) the rotation axis of the camera. From the acquired planar images the distribution of the activity inside the patient's body can be computed using certain reconstruction algorithms. Generally the so-called Expectation-Maximization of the Maximum-Likelihood (EM-ML) algorithm is used, as described by Shepp et al. (IEEE Trans. Med. Imaging 1982; 2:113-122) and by Lange et al. (J. Comput. Assist. Tomogr. 1984; 8:306-316). This iterative algorithm minimizes the effect of noise in SPECT images.

The method defined in the opening paragraph and called the Linear Orbit Acquisition (LOrA) technique, enables the user to obtain reconstructed images with a substantially improved sensitivity-resolution couple. The LOrA tomographic method has been described in the Int. patent application, publ. no. WO 99/09431 and in the non-prepublished European patent application 00200130.3, both in the name of applicant. The collimator used in the former patent application, viz. a fan-beam collimator with a reduced focal length, is situated in such manner with regard to the patient's body, that the collimator focal line is parallel to said body and is made to travel throughout the target organ in the body during acquisition. The rake collimator used in the latter—non-prepublished—patent application is a collimator having in addition to a plurality of collimator septa at least one raised wall, extending in the longitudinal direction of the detector, transversally positioned to said septa and with a substantial portion extending beyond said septa.

The present invention is an improvement of said LOrA-technique and uses a solid-state detector instead of the conventional NaI-crystal for detecting the gamma radiation emitted by the target organ. A solid-state detector, recently studied by Digirad Corp. (see e.g. U.S. Pat. Nos. 5,786,597 and 5,847,396), has the advantages or a better energy resolution, and the elimination of photomultiplier tubes, which makes the detector more stable in time, lighter in weight and therefore better manoeuverable. A serious drawback in using solid-state detectors in gamma camera's is their extremely high price. This expensiveness impedes the application of these detectors, especially in SPECT imaging. In the conventional SPECT imaging technique a detector is needed having a transverse width that exceeds the cross-section of the patient's body and thus measures approximately 50 cm transversely. A solid-state detector with such dimensions should be so expensive, that the advantages do not outweigh the high costs of the detector.

Solid state detectors, at present used in commercially available gamma camera's, have dimensions of approx. 20×20 cm (e.g. a transverse width of 23 cm) and therefore are especially designed for planar imaging. Although SPECT is mentioned in the technical information of the supplier of such camera's, the limited dimensions of the detector allow only a restrictive use by SPECT. Such small detectors can be used, for instance, for the investigation of superficial organs, e.g. for thyroid studies, or for certain cardiac studies or during surgery, but are not suitable for a large variety of organs and for total-body tomography.

It is well-known in the art, that a reduction of the transverse width of the detector in conventional SPECT imaging introduces serious disadvantages, viz. the dreaded truncation effects and a decrease of the sensitivity. In conventional SPECT the sensitivity is proportional to the transverse width of the detector crystal.

Surprisingly, however, it has now been found, that in the above-defined LOrA-tomography a solid-state detector can be used with a reduced transverse width, without any of the above disadvantages occurring. So by using in the LOrA imaging technique a solid-state detector having a reduced transverse width the improved sensitivity with regard to the conventional SPECT technique is unaffected; also no truncation troubles occur. Therefore, the present invention relates to a method of imaging by the above LOrA tomography and is characterized in that the gamma detector is a solid-state detector having a transverse width that is smaller than the cross-section of the patient's body. The method of the present invention offers attractive prospects in SPECT imaging, not only for organ studies but also for total-body tomography, and allows the use of reasonably-priced devices.

In a suitable size the solid-state detector to be used in the method of the invention has a transverse width of between 20 and 30 cm, preferably of approx. 25 cm.

In a favourable embodiment said detector comprises a plurality of closely-packed detecting elements, preferably CZT crystals. CZT (cadmium-zinc-tellurium) crystals are at present most promising for manufacturing solid-state detectors. Such crystals can be packed closely in various manners, with and without a suitable cover, e.g. by glueing the crystals together. One commercially available solid-state detector comprises several thousands of 3 mm-by-3 mm CZT crystals as detector elements. The use of less crystals having larger dimensions is at the expense of the spatial resolution.

Surprisingly it has been found, that upon use of a solid-state detector with less detector elements having larger dimensions in the above-defined LOrA tomography, the spatial resolution is not at all affected. Therefore, the invention also relates to a method of imaging by said LOrA tomography by using a solid-state detector comprising a plurality of closely-packed detector elements, preferably CZT crystals, having dimensions exceeding 5×5 mm, preferably of approx. 9×9 mm.

The invention further relates to a combination of a gamma detector and a collimator, to be used in the above-defined method, wherein the detector is a solid-state detector having a transverse width smaller than the cross-section of the patient's body, as defined above, and wherein the collimator is selected from a fan-beam collimator with a reduced focal length and a rake collimator. In this combination the detector advantageously comprises a plurality of closely-packed detector elements, preferably CZT crystals having preferably the dimensions indicated above.

The invention also relates to a solid-state gamma detector suitable for this combination and comprising a plurality of closely-packed CZT crystals as detector elements, said CZT crystals having dimensions exceeding 5×5 mm, preferably of about 9×9 mm, and to a gamma camera provided with the above detector-collimator combination.

### DESCRIPTION OF A MODEL EXPERIMENT

To acquire real acquisition data, a model experiment has been carried out. In such an experiment the following requirements as to the equipment should be met:

(a) camera plus suitable collimator;

(b) suitable radiation source; and

(c) camera plus collimator should be movable vis-á-vis the radiation source or vice versa.

Ad (a). A suitable fan-beam collimator is used, meeting the requirements of the present invention, namely having a focal length of 12 cm, and, in comparison, a conventional one having a focal length of 20 cm. The detector is a 21×23 mm solid-state detector, comprising closely-packed 3×3 mm CZT crystals as detector elements.

Ad (b). As the radiation source is used a so-called Jaszczak's de luxe phantom, well-known in the art of performing radioactive experiments.

Ad (c). The radiation source is movable relative to the collimator in such manner that it enables the acquisition of images along linear orbits performed in two directions x and y (horizontal and vertical), perpendicular to the SPECT camera rotation axis z.

In the above arrangement, the method of the present invention is performed in such manner that the collimator focal line travels through the radiation source during acquisition. After a suitable acquisition time, the SPECT spatial resolution is determined and compared with that obtained by using a fan-beam collimator with a focal length of 20 cm in the same experiment.

From the images obtained it can be concluded, that the sensitivity does not decrease if the focal length is reduced from 20 to 12 cm. On the other hand, a significant improvement of the spatial resolution is obtained. The spatial resolution obtained according to the method of the invention is surprisingly good, without any visible degradation at increasing distance from the collimator.

1. A method of imaging a target organ in a patient by SPECT, by using a gamma camera having a gamma detector, and by computer reconstructing the distribution of the radioactivity inside the patient's body from planar images, acquired along at least one linear orbit performed in a transverse direction, wherein said gamma detector is provided on its outer surface with a collimator selected from a fan-beam collimator and a rake collimator, said fan-beam collimator having a reduced focal length and focusing to a focal line parallel to the patient's body, and said rake collimator having at least one raised wall extending in the longitudinal direction of the detector, said method being characterized in that the gamma detector is a solid-state detector having a transverse width that is smaller than the cross-section of the patient's body.

2. Method as claimed in claim 1, wherein the solid-state detector has a transverse width of between 20 and 30 cm, preferably of approx. 25 cm.

3. Method as claimed in any of the preceding claims, wherein the solid-state detector comprises a plurality of closely-packed detecting elements, preferably CZT crystals.

4. Method as claimed in claim 3, wherein said detecting elements have dimensions exceeding 5×5 mm, preferably of approx. 9×9 mm.

5. A combination of a gamma detector and a collimator, to be used in the method of any of the preceding claims, said combination being characterized in that the gamma detector is a solid-state detector having a transverse width that is smaller than the cross-section of the patient's body, and in that the collimator is selected from a fan-beam collimator and a rake collimator, said fan-beam collimator having a reduced focal length and focusing to a focal line parallel to the patient's body, and said rake collimator having at least one raised wall extending in the longitudinal direction of the detector.

6. Combination as claimed in claim 5, wherein the solid-state detector has a transverse width of between 20 and 30 cm, preferably of approx. 25 cm.

7. Combination as claimed in any of claims 5 or 6, wherein the solid-state detector comprises a plurality of closely-packed detector elements, preferably CZT crystals.

8. Combination as claimed in claim 7, wherein said detector elements have dimensions exceeding 5×5 mm, preferably of approx. 9×9 mm.

9. A solid-state gamma detector suitable for a combination as defined in claim 8, characterized in that said detector comprises a plurality of closely-packed CZT crystals as detector elements, said CZT crystals having dimensions exceeding 5×5 mm, preferably of approx. 9×9 mm.

10. A gamma camera, provided with a combination of a gamma detector and a collimator, wherein said combination is defined in any of claims 5-8.
